(19) United States
(12) Patent Application Publication
(10) Pub. No.: US 2024/0002290 A1
(43) Pub. Date: Jan. 4, 2024

(54) METHOD FOR PRODUCING CALCINED CLAY

(71) Applicant: FIVES FCB, VILLENEUVE D'ASCQ (FR)

(72) Inventor: Jean-Michel CHARMET, VILLENEUVE D'ASCQ (FR)

(73) Assignee: FIVES FCB, VILLENEUVE D'ASCQ (FR)

(21) Appl. No.: 18/035,127

(22) PCT Filed: Oct. 29, 2021
(86) PCT No.: PCT/FR2021/051910

§ 371 Date: May 3, 2023

(30) Foreign Application Priority Data
Nov. 5, 2020 (FR) FR2011381

(51) Int. Cl. C04B 14/10; C04B 20/02; C04B 20/04

(52) U.S. Cl. CPC C04B 14/106; C04B 20/023; C04B 20/04

(57) ABSTRACT

A method for producing calcined clay having desired colour characteristics. The method includes: a step of calcining a clay in a calcination furnace, the calcination step being carried out under stoichiometric or oxidising conditions, and a step of reducing iron (III) oxides present in the calcined clay in a reduction system separate from the calcination furnace, this reduction step being carried out by injecting a reduction gas, containing hydrogen atoms and placed in direct contact with the calcined clay.

### TECHNICAL FIELD

The invention relates to a method for producing calcined clay. In particular, the invention relates to a method for producing calcined clay intended to be used as a constituent of a cement

### TECHNICAL BACKGROUND

Cement manufacture uses for the most part a fired material, clinker, which is produced from minerals of which the essential constituent is calcium carbonate.

Clinker is obtained from a raw material composed of a mixture of minerals, including in particular clay, a source of aluminosilicates, and limestone, a source of calcium carbonate. These minerals are successively mixed, dried, ground, preheated, decarbonated and then fired and partially melted in a rotary furnace up to a temperature of about 1500° C., then the clinker thus formed is cooled.

Cement is obtained by finely grinding a mixture composed mostly of clinker.

In the method for manufacturing clinker, in addition to the CO2 emissions from the combustion of the fuels used, calcium carbonate obtained mostly from limestone is decarbonated to obtain lime that can be recombined with silicon, aluminium and iron oxides in the rotary furnace in order to form clinker. The decarbonation step frees a substantial quantity of carbon dioxide released into the atmosphere.

National carbon dioxide emission legislation is becoming stricter and requires stakeholders to reduce the quantities released.

Besides clinker, cement contains gypsum for regulating the setting time of mortars and concretes. Cement also contains more and more often, and in ever greater proportions, materials commonly referred to as “supplementary materials” which substitute clinker in order to reduce the environmental impact and cost of cement manufacture.

For example, the clinker substitute materials currently used most are limestone, blast furnace slags, fly ash from coal-fired power plants and natural pozzolana.

Apart from limestone which merely acts as a “filler”, these clinker substitute materials have a pozzolanic action enabling them to take part in the hydraulic setting reaction. This pozzolanic action helps maintain the desired mechanical properties of the mortars and concretes when the proportion of clinker decreases.

Clays containing kaolinite acquire when they are fired, a pozzolanic action and then become excellent clinker substitute materials in cement manufacture. They are also known as “artificial pozzolanas”.

Unlike clinker production, fired clay production emits little CO2.

By judiciously choosing the proportion of clinker while increasing the proportion of fired clay, it becomes possible to produce a cement with the desired properties.

On account of the iron (III) oxides, Fe2O3, contained therein, clay has a reddish colour. In the absence of treatment, adding fired clay to a cement will result in the production of a cement with a pinkish colour.

Cement producers, and end users, seek a grey-coloured cement.

Several methods have been implemented to modify the natural colour of calcined clay and render it greyish.

Among these techniques, mention can be made of a method which consists of chemically reacting iron (III) oxide Fe2O3 molecules to obtain triiron tetraoxides Fe3O4. This is an oxidation-reduction reaction. After a first step of calcining the clay, the latter is sent to a reduction zone when a liquid reducing agent is injected directly onto the clay, particularly gas oil. Gas oil induces conditions which enable a reduction of iron (III) oxides in order to obtain triiron tetraoxides and iron oxides FeO.

Although this method makes it possible to obtain a grey-coloured clay, it has two major drawbacks:
a substantial quantity of diesel for the reduction of iron (III) oxides is injected, impacting the cost of the clay, on one hand, and the environment, on the other,
the reduction reaction must be carried out a high temperature impacting the energy efficiency of this method.

The aim of the invention is that of remedying this drawback.

### SUMMARY OF THE INVENTION

To this end, a method is firstly proposed for producing calcined clay having the desired colour characteristics, wherein it comprises:
a step of calcining a clay in a calcination furnace, said calcination step being carried out under stoichiometric or oxidising conditions,
a step of reducing iron (Ill) oxides present in the calcined clay in a reduction system separate from the calcination furnace, this reduction step being carried out by injecting a reduction gas, containing hydrogen atoms and placed in direct contact with the calcined clay.

This method advantageously makes it possible to obtain a grey-coloured clay by using a small quantity of reagent, significantly less than the quantity used with liquid reagents. Furthermore, this method makes it possible to increase energy efficiency because the reduction step is performed at lower temperatures in relation to a method using liquid reagents.

Various additional features can be provided alone or in combination:
method wherein;
the reduction gas contains gaseous hydrocarbon type reagents, or
the reduction gas contains dihydrogen and carbon monoxide type reagents, or
the reduction gas contains a dihydrogen type reagent, or
the reduction gas contains gaseous hydrocarbon, dihydrogen and carbon monoxide type reagents;
the reduction step includes a calcined clay cooling operation taking place simultaneously with the reduction of the iron (Ill) oxides;
during the cooling operation in the reduction chamber, the temperature of the calcined clay is lowered below a threshold temperature making it possible to prevent the reoxidation of the iron (II) oxides and/or triiron tetraoxides contained in the calcined clay, said threshold temperature being substantially between 300° C. and 600° C.;
the quantity of reduction gas injected in the reduction step corresponds to a quantity substantially between 0.01 and 2 moles of reagents per mole of iron (III) oxide present in the calcined clay;
the method includes an intermediate cooling step between the calcination step and the reduction step, this intermediate cooling step making it possible to cool the calcined clay to a reduction temperature between 300° C. and 800° C.;
the reduction step is carried out at a reduction temperature between 300° C. and 800° C.;
the reduction gas contains gaseous hydrocarbon CₙHₘ type reagents consisting of n carbon atoms and m hydrogen atoms;
the quantity of reduction gas injected in the reduction step corresponds to a quantity substantially between 0.01 and 1 mole of reagents per mole of iron (III) oxide present in the calcined clay;
the reduction gas is a dihydrogen type reagent;
the quantity of reduction gas injected in the reduction step corresponds to a quantity substantially between 0.2 and 2 moles of reagent per mole of iron (III) oxides present in the calcined clay;
the reduction gas is a mixture of dihydrogen and carbon monoxide type reagents;
the quantity of reduction gas injected in the reduction step corresponds to a quantity substantially between 0.2 and 2 moles of reagents per mole of iron (III) oxide present in the calcined clay;
the reduction gas contains a mixture of gaseous hydrocarbon CₙHₘ, dihydrogen and carbon monoxide type reagents;
the quantity of reduction gas injected in the reduction step corresponds to a quantity substantially between 0.05 mole and 2 moles of reagents per mole of iron (III) oxides present in the calcined clay;
the clay contains kaolinite;
the calcination temperature in the calcination step is less than 950° C.;
the calcined clay is capable of being mixed with clinker intended for cement production.

A use is secondly proposed of a method as described above for producing calcined clay intended for cement production.

### BRIEF DESCRIPTION OF THE DRAWINGS

Other features, details and advantages will become apparent upon reading the detailed description hereinafter, and analysing the appended drawings, wherein:

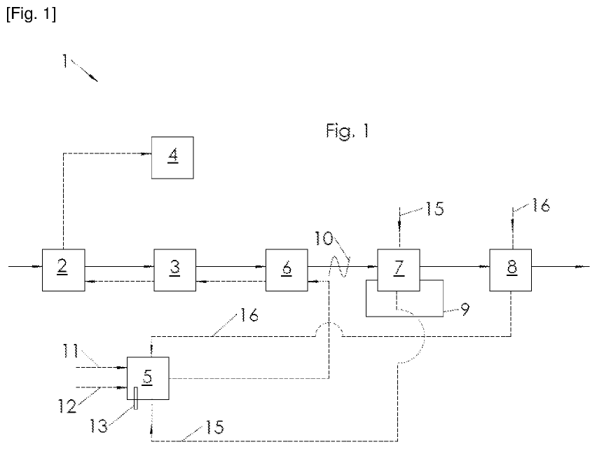

### FIG. 1

FIG. 1 is a schematic representation of an installation according to the invention.

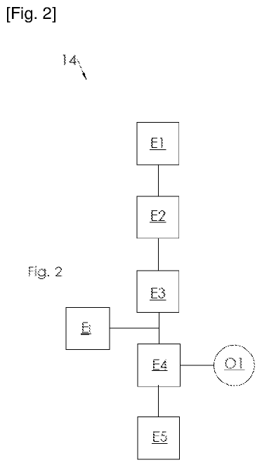

### FIG. 2

FIG. 2 is a schematic representation of a method according to the invention.

### DETAILED DESCRIPTION OF THE INVENTION

The drawings and the description hereinafter contain, essentially, elements. of a definite nature. Therefore, they may not only serve to gain a better understanding of the present disclosure, but also contribute to the definition thereof, where applicable.

In FIG. 1, a calcined clay production unit 1 is shown.

The unit 1 comprises:
a grinder 2,
a preheater 3,
a filter 4,
a combustion chamber 5,
a calcination furnace 6,
a reduction system 7,
a final cooler 8,
a first cooling system 9,
a second cooling system 10.

The routing of the gases and the clay in the production unit 1 represented in FIG. 1 is first described. Air 11 and a fuel 12 are injected into the combustion chamber 5. A burner 13 ignites this mixture in the combustion chamber 5. Hot gases leave the combustion chamber 5 and are sent to the calcination furnace 6, then the preheater 3 and finally to the grinder 2. These hot gases are discharged via the filter 4. In parallel, clay is moved from the grinder 2 to the final cooler 8 respectively via the preheater 3, the calcination furnace 6, the reduction system 7. The air 16 used in the final cooler 8 is conveyed at least partially towards the combustion chamber 5.

Hereinafter, a method 14 according to the invention will be described.

With reference to the drawings, the method 14 according to the invention includes a first step E1 wherein unprocessed clay containing iron (III) oxides Fe2O3 is ground and dried in the grinder 2.

In the drawings, the solid lines represent the path of the clay and the dotted lines indicate the path of the gas flows.

The ground and dried clay is sent to the preheater 3, except the finest fraction which is carried towards the filter 4 by the hot gas flow.

The method includes a second preheating step E2. In the preheater 3, the ground and dried clay is preheated by the hot gases from the calcination furnace 6 up to a temperature between 300° C. and 800° C.

The preheated clay is then routed to the calcination furnace 6. Thus the method includes a third calcination step E3. In order to activate the pozzolanic potential of the calcined clay and render it suitable for use cement production, the calcination is performed at a temperature less than 950° C. Preferably, the calcination is carried out at a temperature between 700° C. and 900° C. The calcination is carried out under stoichiometric or oxidising conditions. In other words, the gaseous flow in the calcination furnace 6 is generated in the combustion chamber 5 by the combustion of the mixture of an oxidiser and a fuel in stoichiometric proportions for a complete combustion or with excess oxidiser for an oxidising combustion. In the embodiment shown in the figures, the combustion chamber 5 is separate from the calcination furnace 6 with essentially air acting as oxidiser. As mentioned above, the hot gases produced in the combustion chamber 5 are sent to the calcination furnace 6 in order to calcine the clay.

The calcined clay is routed to the reduction system 7. Thus, the method includes a fourth step E4 of reducing the iron (III) oxides contained in the calcined clay. Reduction is carried out by injecting a reduction gas 15 containing hydrogen atoms, this gas being placed in contact with the calcined clay. The reduction gas 15 is then sent to the combustion chamber 5.

The reduction gas 15 containing hydrogen atoms makes it possible to reduce the iron (III) oxides according to the following formulas to essentially obtain triiron tetraoxides and optionally iron (II) oxides FeO:

3Fe₂O₃+H₂⇔2Fe₃O₄+H₂O [Chem. 1]

Fe₃O₄+H₂⇔3FeO+H₂O [Chem. 2]

and according to the following formulas, carbon monoxide, when it is present, reacts with the iron (III) oxides:

3Fe₂O₃+CO⇔2Fe₃O₄+CO₂ [Chem. 3]

Fe₃O₄+CO⇔3FeO+CO₂ [Chem. 4]

The use of a gas containing hydrogen atoms rather than diesel or any other liquid fuel as reducing agent makes it possible to significantly reduce the quantity of reducing agent in the reduction step E4. The grey-coloured calcined clay is therefore produced at a significantly lower cost. Furthermore, the environmental impact of grey-coloured calcined clay production is reduced.

The grey-coloured calcined clay is then routed to the final cooler 8, where the calcined clay is cooled with air. The method thus comprises a fourth final cooling step E5.

Advantageously, the reduction gas 15 contains:
gaseous hydrocarbon type reagents of generic formula CₙHₘ, or
a mixture of dihydrogen H2 and carbon monoxide CO type reagents, or
a dihydrogen H2 type reagent, or
a mixture of gaseous hydrocarbon type reagents of generic formula CₙHₘ, dihydrogen, and carbon monoxide.

It should be noted that these gases can be mixed with other gases, essentially nitrogen and/or carbon dioxide.

Advantageously, the fourth reduction step E4 includes a cooling operation O1 using the first cooling device 9. The cooling operation O1 takes place simultaneously with the reduction of the iron (III) oxides. This makes it possible to reduce the temperature of the calcined clay during the fourth reduction step E4 in order to prevent reoxidation of the iron (II) oxides and/or triiron tetraoxides after said fourth reduction step E4 and at the outlet of the reduction system 7.

Advantageously, the cooling operation O1 in the fourth reduction step E4 is carried out by means of a cooling fluid either without direct contact with the calcined clay or by direct contract with the calcined clay if the cooling fluid contains less than 10% dioxygen by volume, for example combustion gases extracted at the outlet of the preheater 3 or the calcination furnace 6. This makes it possible to prevent any significant reoxidation of the iron (II) oxides and/or triiron tetraoxides during and after said fourth reduction step E4.

Advantageously, during the cooling operation O1 in the reduction system 7, the temperature of the calcined clay is lowered below a threshold temperature between 300° C. and 600° C., making it possible to prevent reoxidation of the iron (II) oxides and/or triiron tetraoxides.

Advantageously, the quantity of reduction gas 15 injected in the reduction step E4 corresponds to a quantity substantially between 0.01 and 2 moles of reagents per mole of iron (III) oxides present in the calcined clay. By observing this proportion, a calcined clay with desired greyish colours is obtained, while minimising the gas supply, which makes it possible to reduce the production costs of the clay and its environmental impact.

Advantageously, the method comprises an intermediate cooling step Ei between the third calcination step E3 and the fourth reduction step E4, the intermediate cooling step Ei being implemented by means of the second cooling device 10. The intermediate cooling step Ei makes it possible to cool the calcined clay to a reduction temperature between 300° C. and 800° C. This intermediate cooling step Ei is carried out before the calcined clay enters the reduction system 7. This intermediate cooling can be performed by any usable means, particularly by air. By cooling the calcined clay before the reduction system 7, it is possible to improve the energy efficiency of the production unit 1. The cooling heat energy is used for other applications, in the same method or for another use. This is enabled thanks to the use of a gas containing hydrogen atoms as reducing agent, which enables a reduction of the iron (III) oxides to lower temperatures than in a method using a liquid reducing agent in particular.

Thus, hence, the fourth reduction step E4 is carried out at a reduction temperature between 300° C. and 800° C. This reduction temperature makes it possible to improve the energy efficiency of the production unit 1.

According to a first embodiment of the invention, the reduction gas 15 contains gaseous hydrocarbons of generic formula CₙHₘ type reagents consisting of n carbon atoms and m hydrogen atoms. This gas has the benefit of being readily available and contains numerous hydrogen atoms, which makes it particularly useful.

The reduction gas 15 contains for example methane, propane or butane. In this first embodiment, this reduction gas 15 undergoes in the reduction system 7 partial dissociation reactions in the presence of dioxygen O2, carbon dioxide CO2 and water vapour H₂O contained in the combustion gases. Indeed, the calcined material transports with it, between the particles, a small quantity of combustion gases. The dissociation reactions are as follows:

$$\begin{matrix}{C}_{n} {H}_{m} + \frac{n}{2} {O}_{2} ⇔ \frac{m}{2} {H}_{2} + n CO & [ Chem . 5 ] \\ {C}_{n} {H}_{m} + n {CO}_{2} ⇔ \frac{m}{2} {H}_{2} + 2 n CO & [ Chem . 6 ] \\ {C}_{n} {H}_{m} + n {H}_{2} O ⇔ ( \frac{m}{2} + n ) {H}_{2} + n CO & [ Chem . 7 ]\end{matrix}$$

In the first embodiment, the reduction gas 15 is therefore in a first phase partially converted into a mixture of dihydrogen and carbon monoxide.

The quantity of gaseous hydrocarbon type reagents of generic formula CₙHₘ injected in the reduction step is substantially between 0.01 mole and 1 mole of reagents per mole of iron (III) oxides present in the calcined clay. The applicant determined that this quantity makes it possible to obtain the desired greyish colours while minimising this quantity so as to reduce the production cost of the calcined clay while reducing the environmental impact.

According to a second embodiment of the invention, the reduction gas 15 contains a dihydrogen type reagent. This gas makes it possible to prevent the production of carbon oxides during the reduction step.

The quantity of dihydrogen type reagent injected in the reduction step is substantially between 0.2 mole and 2 moles of reagent per mole of iron (III) oxides present in the calcined clay. The applicant determined that this quantity makes it possible to obtain the desired greyish colours while minimising this quantity so as to reduce the production cost of the calcined clay while reducing the environmental impact.

According to a third embodiment of the invention, the reduction gas 15 contains a mixture of dihydrogen and carbon monoxide type reagents. This gas has the benefit of being easy to synthesise in-situ in a dedicated reactor, commonly known as “endogas generator”.

The quantity of this mixture of dihydrogen and carbon monoxide type reagents injected in the reduction step is substantially between 0.2 mole and 2 moles of reagents per mole of iron (Ill) oxides present in the calcined clay. The applicant determined that this quantity makes it possible to obtain the desired greyish colours while minimising this quantity so as to reduce the production cost of the calcined clay while reducing the environmental impact.

According to a fourth embodiment of the invention, the reduction gas 15 contains a mixture of gaseous hydrocarbon of generic formula CₙHₘ, dihydrogen and carbon monoxide type reagents. This gas has the benefit of being easy to synthesise in-situ in a dedicated reactor, commonly known as “exogas generator”.

The quantity of this mixture of gaseous hydrocarbon, dihydrogen and carbon monoxide type reagents injected in the reduction step is substantially between 0.05 mole and 2 moles of reagents per mole of iron (Ill) oxides present in the calcined clay. The applicant determined that this quantity makes it possible to obtain the desired greyish colours while minimising this quantity so as to reduce the production cost of the calcined clay while reducing the environmental impact.

Advantageously, the unprocessed clay used in this production method 14 comprises kaolinite. This type of clay enables use as a partial clinker substitute in cement production.

Thus, the calcined clay obtained by means of the method described above can be mixed with clinker intended for cement production.

The invention also relates to the use of the method 14 described above for producing calcined clay intended for cement production. Such a use makes it possible to produce a greyish-coloured cement, by reducing the proportion of clinker in the cement by replacing it with calcined clay. The cement thus obtained has a desired greyish colour and mechanical properties substantially identical to that of a cement with no calcined clay.

1-18. (canceled)

19. A method for producing calcined clay having desired colour characteristics, comprising:
a step of calcining a clay in a calcination furnace, said calcination step being carried out under stoichiometric or oxidising conditions,
a step of reducing iron (III) oxides present in the calcined clay in a reduction system separate from the calcination furnace, this reduction step being carried out by injecting a reduction gas, containing hydrogen atoms and placed in direct contact with the calcined clay.

20. The method according to claim 19, wherein:
the reduction gas contains gaseous hydrocarbons, or
the reduction gas contains dihydrogen or carbon monoxide, or
the reduction gas contains dihydrogen, or
the reduction gas contains gaseous hydrocarbons, dihydrogen and carbon monoxide.

21. The method according to claim 19, wherein the reduction step includes a calcined clay cooling operation taking place simultaneously with the reduction of the iron (III) oxides.

22. The method according to claim 21, wherein, during the cooling operation in the reduction chamber, the temperature of the calcined clay is lowered below a threshold temperature making it possible to prevent the reoxidation of the iron (II) oxides and/or triiron tetraoxides contained in the calcined clay, said threshold temperature being between 300° C. and 600° C.

23. The method according to claim 20, wherein the quantity of reduction gas injected in the reduction step corresponds to a quantity between 0.01 and 2 moles of reagents per mole of iron (III) oxide present in the calcined clay.

24. The method according to claim 19, wherein it includes an intermediate cooling step between the calcination step and the reduction step, this intermediate cooling step making it possible to cool the calcined clay to a reduction temperature between 300° C. and 800° C.

25. The method according to claim 19, wherein the reduction step is carried out at a reduction temperature between 300° C. and 800° C.

26. The method according to claim 20, wherein, the reduction gas contains gaseous hydrocarbons CₙHₘ consisting of n carbon atoms and m hydrogen atoms.

27. The method according to claim 26, wherein the quantity of reduction gas injected in the reduction step corresponds to a quantity between 0.01 and 1 mole of reagents per mole of iron (III) oxide present in the calcined clay.

28. The method according to claim 20, wherein, the reduction gas is dihydrogen.

29. The method according to claim 28, wherein the quantity of reduction gas injected in the reduction step corresponds to a quantity between 0.2 and 2 moles of reagent per mole of iron (III) oxides present in the calcined clay.

30. The method according to claim 20, wherein, the reduction gas contains a mixture of dihydrogen and carbon monoxide.

31. The method according to claim 30, wherein the quantity of reduction gas injected in the reduction step corresponds to a quantity between 0.2 and 2 moles of reagents per mole of iron (III) oxide present in the calcined clay.

32. The method according to claim 20, wherein, the reduction gas contains a mixture of gaseous hydrocarbons CₙHₘ, dihydrogen and carbon monoxide.

33. The method according to claim 32, wherein the quantity of reduction gas injected in the reduction step corresponds to a quantity between 0.05 and 2 mole of reagents per mole of iron (III) oxides present in the calcined clay.

34. The method according to claim 19, wherein, the clay contains kaolinite.

35. The method according to claim 19, wherein, the calcination temperature in the calcination step is less than 950° C.

36. A method for cement production, comprising producing calcined clay having desired colour characteristics according to the method of claim 19.
